(19) United States
(12) Patent Application Publication
(10) Pub. No.: US 2014/0333633 A1
(43) Pub. Date: Nov. 13, 2014

(54) APPARATUSES AND METHODS FOR POLICY AWARENESS IN HARDWARE ACCELERATED VIDEO SYSTEMS

(71) Applicants: Qing Zhang, Shanghai (CN); Jieke Wu, Shanghai (CN); Danming Xie, Shanghai (CN)

(72) Inventors: Qing Zhang, Shanghai (CN); Jieke Wu, Shanghai (CN); Danming Xie, Shanghai (CN)

(21) Appl. No.: 13/995,320

(22) PCT Filed: Dec. 29, 2011
(86) PCT No.: PCT/CN2011/084929

§ 371 Date: Mar. 27, 2014

(51) Int. Cl. H04N 21/426

(52) U.S. Cl. CPC H04N 21/42653; H04N 21/42607
USPC 345/503

(57) ABSTRACT

Apparatuses and methods for prioritizing the allocation of video acceleration hardware in video playback systems. Smooth, high-definition video playback may be provided with a system that may include multiple web browsers, web browser tabs, video players, or media players by allocating hardware acceleration resources to for individual videos based on each video's priority in a predefined priority configuration. Priority of an individual video may be based on the visibility of the video to a system user or the order in which a video was requested by a user. Videos that are visible on a display screen may have a higher priority than videos that are hidden or obscured. Videos that are started or opened more recently than other videos may have a higher priority. A priority management unit may coordinate the allocation of video playback acceleration resources dynamically as the priority ranking of videos change in response to user input.

### BACKGROUND

User equipment (UE) may include computers, smart phones, laptops, set-top boxes, video game consoles, or other network enabled devices. Such equipment may be configured to provide video playback, but may have limited resources (e.g., processor capability, battery life, etc.) for video rendering. The resource limits of equipment may impact the ability of the equipment to provide smooth video-playback in high definition (HD) that is acceptable to users. The speed of both wired and wireless networks have increased, and users are increasingly demanding high quality video performance from their equipment. For example, HD video is becoming more widely available on these networks. Dedicated video acceleration hardware may enhance video playback performance. However, due to physical limits on the number of channels that may be supported at any one time, dedicated hardware cannot handle all usage scenarios that a user may expect. Example usage scenarios may include multi-window web browsing, multi-tab video playback, multi-video-in-one-tab playback, multiple media players, or other configurations with more than one active video or multi-media player.

The video decoding pipeline and video rendering processes in a typical video playback system may be computationally intensive and may greatly impact overall system performance of UE. The processing demands of HD video may slow down UE response times, or introduce overall system lag or unresponsiveness. The failure of UE to handle the performance needs of video playback may result in an undesirable user experience and user frustration.

General solutions to optimize processor-limited applications include the use of parallel computing, single-instruction multiple-data (SIMD) instruction sets, or a dedicated hardware engine to accelerate the decoding pipeline. However, the video rendering process may still be a bottleneck that may limit overall system performance. For example, different formats of decoded data may require additional memory accesses before providing the decoded data to an appropriate video rendering engine, which may cause latency in the rendering process. Alternative solutions such as upgrading processor capability may improve performance; however, processor upgrades often require a tradeoff cost in the form of sacrificed battery life or increased size for mobile devices.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram illustrating an example video playback system of the prior art.

FIG. 2 is a block diagram illustrating an example video acceleration system, including a page management unit and hardware engine, according to an embodiment.

FIG. 3 is a block diagram illustrating example interaction of a page management unit with multiple requests for video resources, according to an embodiment.

FIG. 4 illustrates a diagram depicting an example prioritization ranking of various attributes, according to one embodiment.

FIG. 5 is a flow chart illustrating an example scheme for managing priority decision process, according to an embodiment.

FIG. 6 is a diagram illustrating an example web browser interface, including two video playback areas, according to an embodiment.

FIG. 7 is a block diagram illustrating an example machine upon which one or more embodiments may be implemented.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

In an example, a video acceleration system may manage the presentation of multiple videos with different or identical video protocols. For example, video formats such as QuickTime®, Moving Picture Experts Group (MPEG), or Audio Video Interleave (AVI) may all be managed with the appropriate media players or codecs in a single environment. One example environment is web browser equipped with an HTML5-compatible rendering engine. In an example, videos may be presented and managed in one or more windows, tabs, or media player canvases. In one example, an HTML5-compatible web browser may operate on a portable computing device, for example a smart phone, and coordinate the playback of multiple concurrent video presentations.

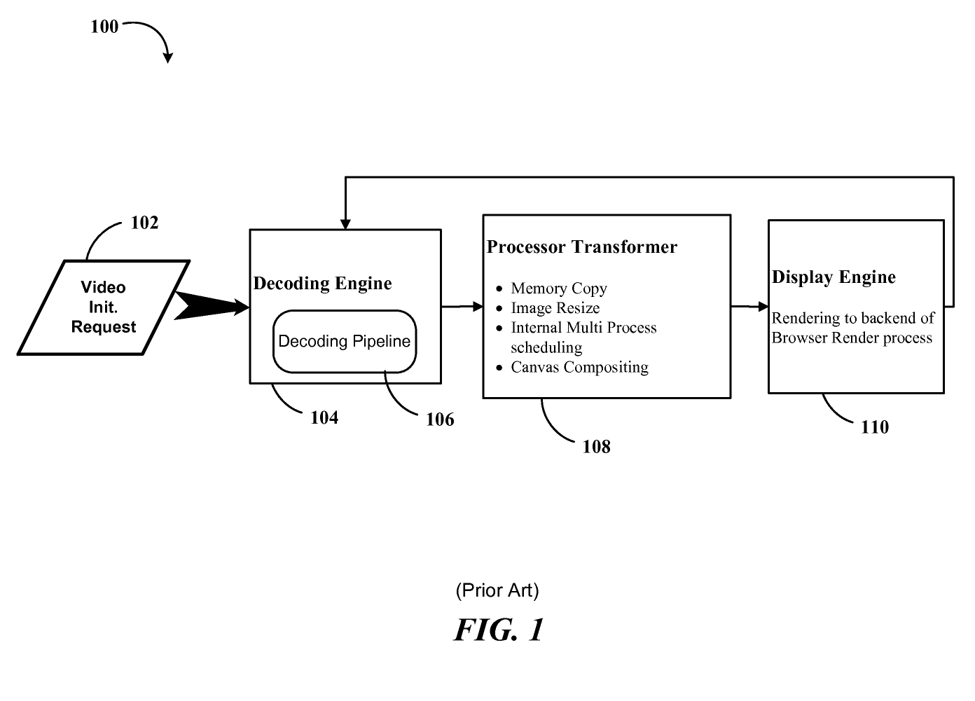

FIG. 1 illustrates an example of a video playback system 100 to handle video initialization requests 102. The video playback system 100 may utilize a decoding engine 104 to process and present a video, such as a video presented in a web page formatted with an HTML5 canvas, in a web browser. Web browsers are typically present on a UE, including both desktop and mobile computing devices, to allow a user to interact with multimedia received over a network or previously loaded onto the UE. Videos in a variety of formats that are compatible with the HTML5 standard are available from any number of websites hosted on the Internet and generally supported in modern web browsers. In a typical web browser, a decoding engine 104 utilizes a decoding pipeline 106, along with a display engine 110 to process and present a video to a user.

The video data may be transformed or rendered as it is transferred from the decoding engine 104 to the display engine 110 by a processor transformer module 108 that utilizes a memory copy of each video frame received from the decoding pipeline 106 to perform any desired manipulations on the video frame. Video frame manipulations may include, for example, resizing, color conversion, or compositing video frames.

Some computers and mobile devices with limited processor computation capability may not be able meet the requirements necessary to properly render and decode a high quality video stream at a rate that is fast enough to properly display multiple videos. One solution to processor limited devices is to include a dedicated hardware engine, for example a graphics processing unit (GPU), that may accelerate the video decoding and color space conversion processing during video processing. Video decoding and color space conversion are computationally intensive processes that may benefit from dedicated hardware components, sometimes referred to as video processors.

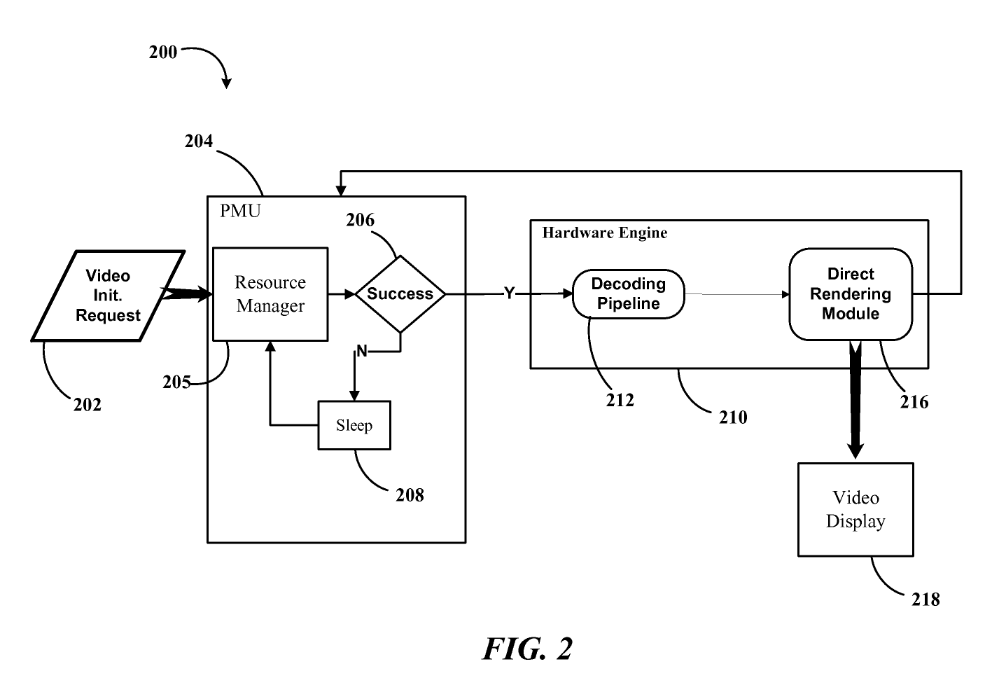

FIG. 2 illustrates an example of a video acceleration system 200 to accelerate video display and to manage multiple video initialization requests. The video acceleration system 200 may be implemented in a variety of computing systems, including but not limited to, mobile phones, desktop computer, smart phones, or any other apparatus that includes a mechanism to provide video playback to a user. The video acceleration system 200 may be utilized in scenarios where multiple videos may be played or queued concurrently. Accordingly, one potential advantage of the video acceleration system 200 is that video playback performance may be optimized appropriately prioritizing the playback of each individual video.

In an example, a video initialization request 202 is received by a playback management unit (PMU) 204 to initiate a request for a video resource. A request may originate, for example, from a user activating a link in a web browser that is associated with a video the user wishes to view. The PMU 204 may manage hardware resource sharing, optimize limited resources allocation, coordinate the assignment of hardware recourses to requesters, and also may include a priority scheme defining how requests are handled. In response to a video initialization request 202, the PMU 204 may determine if a resource requested or required by the video request 202 is available. If a resource is in use, the PMU 204 may determine if the request should wait for the resource to become available, or if the existing owner of the resource should be forced to release the resource.

In an example scenario where there are no currently playing videos, the PMU 204 may determine that a requested resource may be immediately granted to the requester. A priority handling resource manager 205 performs a check operation 206 to determine if the resource is available. If the PMU 204 determines that the resource is unavailable, due to use by a higher priority request, the video initialization request 202 is placed in a sleep state 208 until the resource becomes available. If the PMU 204 performs the check operation 206 and determines that the resource is available, or is of a higher priority than an existing request that is utilizing the resource, the video initialization request 202 is delivered to a hardware engine 210.

The hardware engine 210 may accelerate both the decoding pipeline 212, and also the rendering process with a direct rending module 216. The output data from the decoding pipeline 212 is rendered directly to a hardware overlay at the appropriate time to display the video, so there is no redundant data copy between the decoding and rendering pipelines. The elimination of a memory copy between the decoding and rendering pipelines may improve the video playback performance. Both the decoding pipeline 212 and the rendering process may be accelerated by a dedicated hardware module.

In an example, a direct rendering module 216 may be used to eliminate the speed gap between hardware decoding and software rendering as well as to avoid frame drops. The latency typically associated with a data copy and a format conversion in rendering process is eliminated by directly passing the decoded video content from the decoding pipeline 212 to the direct rendering module 216 without the use of a separate memory copy, which could be exist in an example where the decoding pipeline 212 and the direct rendering module were not included in a hardware engine 210.

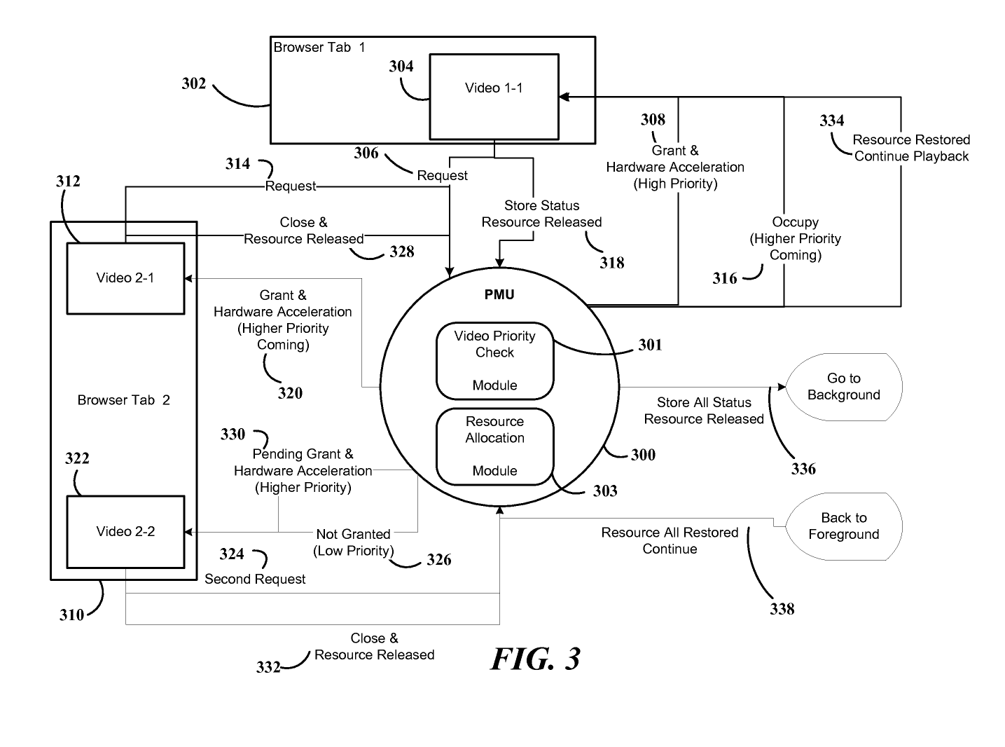

FIG. 3 illustrates an example of two web browser tabs interacting with a PMU 300. Each web browser tab may include a separate or shared media player to present videos to a user. The PMU 300 may include a video priority check module 301 and a resource allocation module 303. The video priority check module 301 may maintain a database, list, or other priority scheme that may indicate how resources should be allocated if two or more requests are made for an individual resource. The resource allocation module 303 may maintain a database, list, or other mechanism to monitor how individual resources in a system are being utilized.

For example, during the instantiation of a new web media player for an HTML5 video, a resource request may be sent by each tab or web media player requester to the PMU 300. The PMU 300 may be configured to manage all hardware resources associated with video playback or acceleration for playback. During a resource acquisition, the PMU 300 may probe resource statuses by querying a system resource manager (not shown). When video playback is complete, or a preemptive request is received from a higher priority video, each player for a video may be signaled to suspend playback, store playback context if the playback is not complete, release the hardware pipeline resource, and also notify the PMU 300 that the resource has been released.

For example, a first browser tab 302 may be directed by a user to open a web page that includes a first video 304. A request 306 from the first browser tab 302 is sent to the PMU 300. The video priority check module may determine the priority of the request from the first browser tab 302. The resource allocation module may check to determine if the resource requested by the first browser tab 302 is available. When there are no other videos utilizing resources on the system the PMU 300 transmits a response 308 granting the request and providing a hardware resource to accelerate the playback of the first video 304 in the first browser tab 302. In this example where only one video being presented, the first video 304 has the highest priority in the system. When the requesting browser tab 302, or media player, receives response 308, the requester may begin the creation of a new video playback pipeline, an example of which is depicted in FIG. 2.

The PMU 300 may reallocate a hardware resource to a higher priority requester, or wake up a pending video player that is waiting for the resource. A pending player may re-initializes the hardware pipeline upon receipt of a wake-up signal, restores any previously stored playback context, and resumes video playback at the exact point where the video player was previously suspended.

For example, in a web browser that allows multiple windows or tabs to be open or active simultaneously, a user may request a second browser tab 310. When a user requests a second browser tab 310, the first browser tab 302 may be obscured by the new second browser tab 310. Alternatively, the first browser tab 302 may still be visible if the first browser tab 302 and the second browser tab 310 are in different windows or in an arrangement where they are both visible to the user. The second browser tab 310 may include a second video 312. The second video 312 may be present in an initial web page loaded in the second browser tab 310 or the result of user navigation to a web page that includes second video 312. The second video 312 in the second browser tab 310 may send a request 314 to the PMU 300 requesting a video acceleration resource.

In an example where video priority is based on the active or foreground status of a browser tab, the second video 312 in the second browser tab 310 will have a higher priority than the first video 304 in the first browser tab 302 when the second browser tab 310 is in front of, or more recently selected, than the first browser tab 302. The selection of the first browser tab 302 by a user may reverse the priority of the videos by causing the first video 304 to be in a foreground status and potentially preempting the user of hardware resources in use by second video 312.

The video priority check module may determine the priority of the request 314 from the second browser tab 310 by taking into account the position or status of both the second browser tab 310 and the first browser tab 302. The resource allocation module may check to determine if the resource requested by the second browser tab 310 is available. If the resource requested by the second browser tab 310 is in use by the first video 304 in the first browser tab 302, the PMU 300 may send an occupy notification 316 to the first browser tab 302. The occupy notification 316 may indicate to the first browser tab 302 that the resource being utilized by the first video 304 is requested by a higher priority video and should be released. The first browser tab 302 may store the status of the first video 304 and release the requested resource. The saved status of the first video 304 may be stored in volatile or non-volatile memory based on the memory resources available to the web browser or media player that is presenting the first video 304 to the user. The first browser tab 302 may provide a release notification 318 to the PMU 300 once the status of the first video 304 has been stored.

Upon receipt of the release notification 318 the PMU may grant the resource 320, in response to the request 314 for a hardware acceleration resource, to the higher priority second video 312. The first video 304 in the first browser tab 302 may be suspended in a sleep state until it is promoted to a higher priority that would allow the first video 304 to preempt the use of a needed hardware acceleration resource or until the resource is released by the higher priority user. Alternatively, the first video 304 may continue to be presented in a visible background area or partially obscured portion area at a lower frame rate without the use of hardware acceleration.

Individual display windows or browser tabs may have multiple concurrently active videos in a single window. For example, as illustrated in FIG. 3, a third video 322 may be presented in the second browser tab 310. The video priority module may be configured to prioritize multiple videos in a single window or browser tab. For example, a second video 312 presented in the second browser tab 310 may have a higher priority than a third video 322 in the same tab 310. When a third video 322 is presented in the second browser tab 310, the PMU 300 receives a second request 324 from the second browser tab 310. The PMU may determine that the hardware acceleration resource requested by the third video 322 is in use and return a no-grant response 326 to the third video 322. If the resource is not available, the requester may fall into a sleep state to wait for the resource, or attempt to present the video without hardware acceleration. In the sleep state the second request 324 may be placed in a queue to wait for a wake signal, which may be provided by the PMU 300, indicating that the requested resource has become available.

When a video has completed playback, is manually stopped by a user, or is otherwise unable to continue playing, the resources being utilized by that video are released. For example, when the second video 312 in the second browser tab 310 is complete, a notification 328 is provided to the PMU 300 indicating that the resource or resources associated with the second video 312 may be released, thereby making the resources available to other requesters. Upon receipt of notification 328, the PMU 300 will check to determine which video, if any, are next in the priority queue. In the example depicted in FIG. 3, the third video 322 in the second browser tab 310 becomes the highest priority video resource request upon the completion of the second video 312. The PMU 300 may provide the second browser tab 310 with a grant response 330 that removes the third video 322 from the sleep queue or a list of waiting requesters. The process of granting the request of a video that has not yet begun the playback process may include the creation of a new video playback pipeline, an example of which is depicted in FIG. 2.

The third video 322 may be presented in the second browser tab 310 until it is interrupted by a higher priority video request, a change is made to its priority status that would require the release of any allocated resources, or the point at which the third video 322 has completed playback. Upon completion of playback, or an event closing the second browser tab or a media player associated with the third video 322, a notification 332 may be provided to the PMU 300 indicating that a resource is being released for potential reassignment by the resource allocation module.

The PMU 300 may provide a restore playback notification 334 to the first browser tab 302 when the resource requested for use by the first video 304 becomes available. The first browser tab 302 may restore that saved status of the first video 304 and continue with hardware accelerated playback with the media playback pipeline that was originally created for the first video 304.

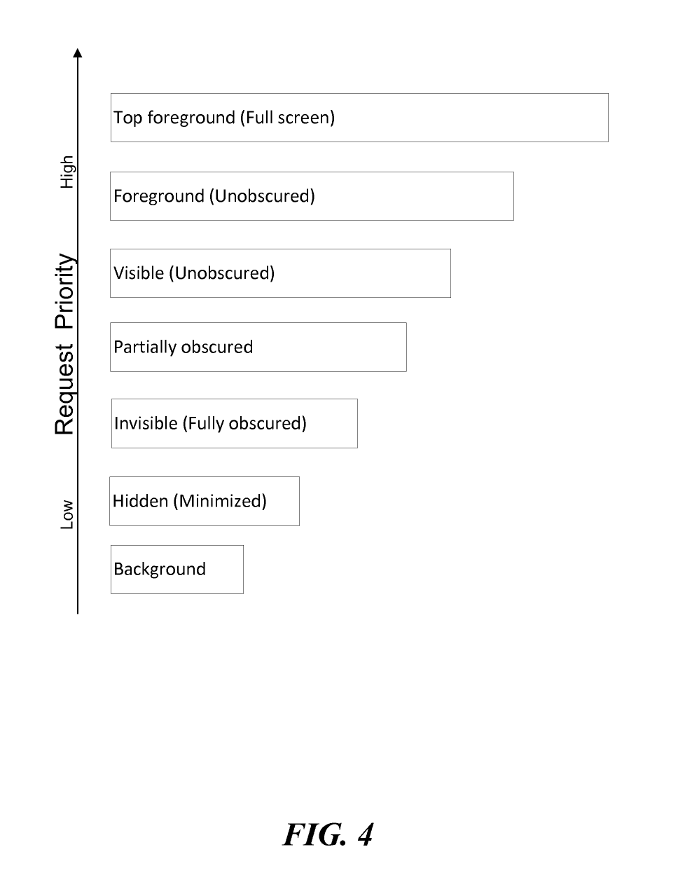

A system of ranking the priority of videos may be based on visibility attributes that characterize the amount of display area of the video to the user. A visibility attribute can indicate whether all of a video, a portion of a video, or none of a video is visible to a user on a display screen. FIG. 4 illustrates an example diagram of priority rankings of visibility attributes for various web browsers, media players, or other video playback areas. A video playback area may include any portion of a display, for example an HTML5 canvas that includes a video tag, which is configured to present a video to a user.

In the illustration depicted in FIG. 4 an attribute indicating that a video is in the top-most foreground window or a maximized display area is assigned the highest priority. The next highest priority attribute would include a video that is in a foreground display area and is unobscured. A visible window that is not maximized or a foreground window, but is fully visible (unobscured) is the next highest priority level. As illustrated in FIG. 4, a partially visible video that includes an attribute indicating that the video is not in the foreground display area may be assigned a priority that is lower than foreground videos, but is also higher than any video that is not visible to the user.

Videos that are invisible, for example due to controls, menus, or other web page elements that obscure the video display area, may be assigned a priority that is lower than fully visible or partially visible videos. Hidden videos are videos that are in a non-visible display area, minimized such that no portion of the video display area may be observed by a user. A lowest level attribute, indicating that a video is relegated to a background display area, or other user or operating system assigned low-priority area or space, may be assigned the lowest priority background level.

In addition to ranking the priority of videos based on visibility attributes, video order attributes may be utilized to prioritize videos for hardware acceleration. Video order attributes may include the relative order in which a video was started, opened, or selected by a user, or the video's status as being in an active, minimized, or background window in a multi-window operating system.

Combinations of video attributes such as visibility, order, and status (e.g., paused, playing, etc.) can all be combined into priority levels, to construct tie-breaker criteria that may also be used to provide a PMU with a ranking for each video in any display configuration that may be achieved on an individual video playback device. For example, in a web page that includes two concurrent videos that are both visible, the video that was most recently selected to begin playing by a user (an higher priority order attribute) may have a higher priority overall despite having identical visibility priority attributes.

The priority of video player requesters may dynamically shift based on changing situations or orientations. Priority may change if a video player becomes visible or is hidden, if the video is moved from a background or a foreground display area or vice-versa. If the video is in a window, web browser, or media player that is minimized, maximized on the entire display screen, or closed the priority of the video is reassigned to reflect the change. A priority may change if the status of a video is changed, for example if a user pauses a video, changes the video playback rate, or resumes playing a paused video. A list, database, array, or other memory structure that includes one or more attributes of each video, window, web browser, media player, embedded media player or other video display area, may be maintained and updated in a machine readable medium by a PMU.

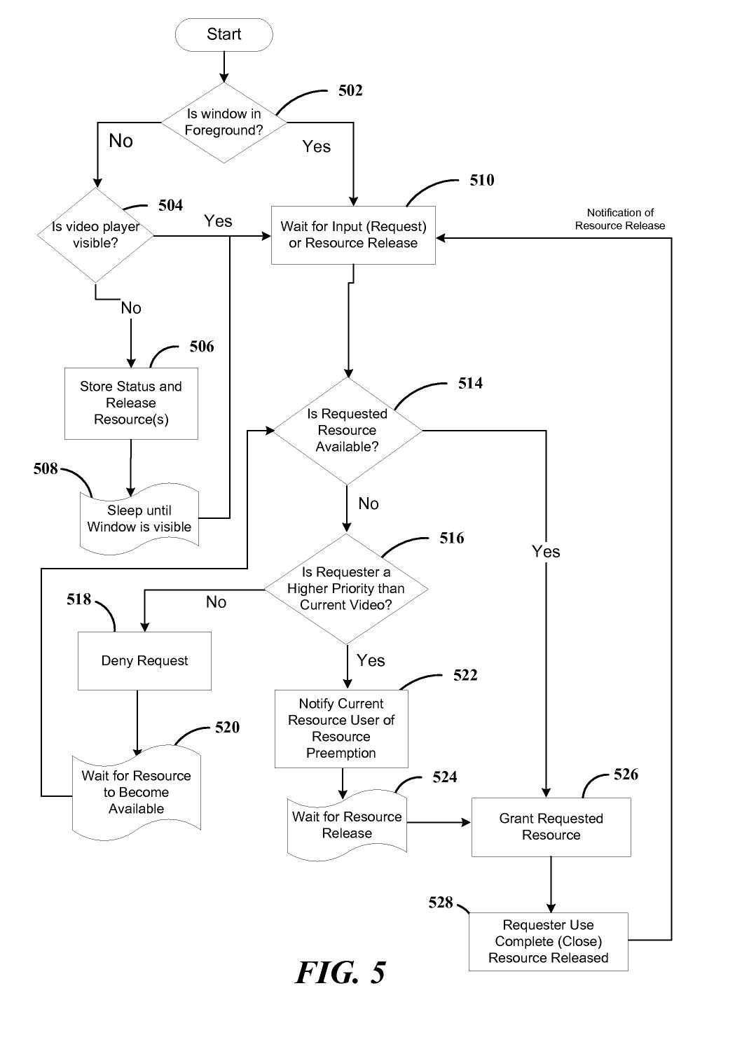

FIG. 5 is a flowchart illustrating an example method of prioritizing resource handling requests in a PMU that prioritizes video players for hardware acceleration. The PMU may wait for resource requests or status changes in resource use or priority adjustments that may affect the allocation of resources. At foreground check operation 502, the PMU first checks if web browser or media player window is in the foreground. A foreground window may be the most prominent, most recently selected, or most recently created window that is fully visible to a user. If the window is not in the foreground window, at visibility check operation 504, the PMU checks to determine if the video is visible in a background window. A background window is any window that is not selected as the foreground window, or is obscured, at least in part, by any other window.

At operation 506, if the video is not visible in a background window, then the status of the video is stored and any hardware resources held by the video are released back to the PMU. At operation 508, a non-visible window may be placed in a sleep state. An example of a non-visible window may include a web browser tab that is created by a user as a background window. The browser tab may load a web page that includes a video but the PMU would not assign hardware acceleration resources to the video because the video is not visible to the user. In this manner, hardware resources may be prioritized for videos that are visible to the user.

At operation 510, the PMU may wait for new resource requests or status changes in resource use or priority adjustments that may affect the allocation of resources. When a resource request originates from a window that is either the foreground window (as determined at the foreground check operation 502) or contains a visible video player (as determined at visibility check operation 504) an availability check is performed at operation 514. The availability check operation 514 may be performed by a resource allocation module in the PMU. If the requested resource is in use, at operation 516 the PMU may determine if the new request is from a requester that has a higher priority than the current user of the resource. If the requester does not have a greater priority level than the current user of the resource, the request is denied. At operation 518, the PMU may notify the requester that the resource is unavailable. At operation 520, the request may be placed in a queue or other memory structure to wait for the resource to become available.

If, at operation 516, the PMU determines that the requester has a priority higher than the existing user, then at operation 522 the PMU may notify the existing user and preempt the use of the resource. At operation 524, the PMU may wait for the current resource user to store its current state and release the resource to the PMU. At operation 526, the PMU may grant the use of a requested resource to the requester.

At operation 528, the PMU may monitor the use of any allocated resources to determine if a resource has been released by a requester. A requester may release a resource by stopping or pausing video play back, by navigating away from a webpage with a video in a web browser that is utilized a hardware resource allocated by the PMU, or by terminating an application that is utilizing a hardware resource allocated by the PMU. The PMU may periodically poll the requesting application, process, web browser, media player, or other requester for resource status. Alternatively, the PMU may be notified of resource use changes with a software message or interrupt provided by an operating system. After the requester is finished with the resource, a notification is transmitted to the PMW and the PMU returns to operation 510 to wait for another resource request.

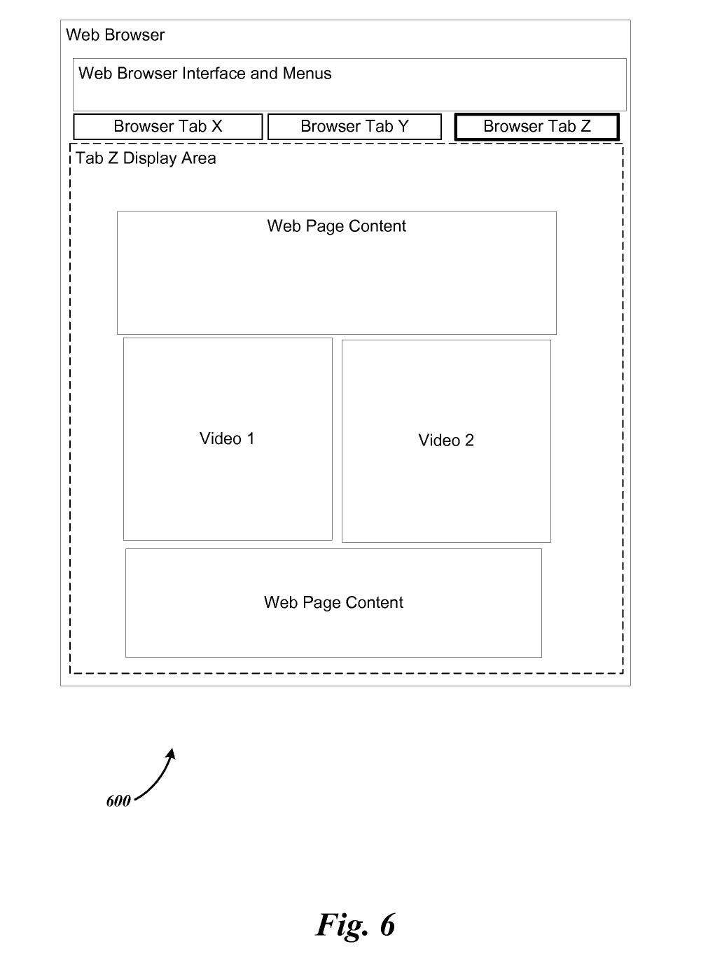

FIG. 6 illustrates an example diagram of a web browser 600 with multiple browsing tab capabilities. Web browser 600 may include a web browser interface area and a plurality of menus. In the example depicted in FIG. 6, the web browser 600 includes multiple browser tabs. Browser Tab Z is highlighted as being the currently active tab and includes a display area with web page content and two video display areas. Browser Tab X and Browser Tab Y are inactive tabs that are not currently visible to a user. Browser Tab X or Browser Tab Y may also include web page content or video display areas.

In the example web browser 600 of FIG. 6, an active video in either the first or second video display areas have a higher priority than any video elements that may be present in either Browser Tab X or Browser Tab Y. The visible video elements are prioritized by a PMU in order to provide smooth video playback. The priority of the video elements may change in response to user interaction with the web browser 600. For example, if a user were to select Browser Tab X, causing Browser Tab Z to no longer be visible to the user, a PMU would lower the priority ranking of the first and second video elements in Browser Tab Z and promote any video elements in Browser Tab X. In response to the change in priority, the PMU may dynamically allocate any available hardware acceleration channels, or preempt the use of any hardware acceleration resources in use by the first or second video elements, for use by Browser Tab X.

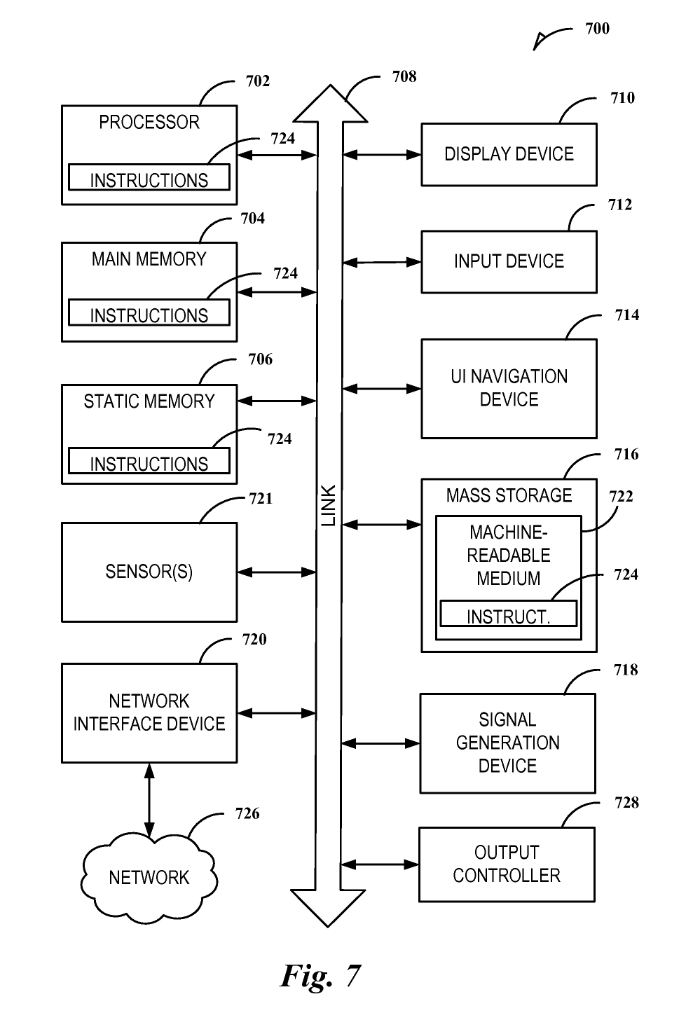

FIG. 7 illustrates a block diagram of an example machine 700 upon which any one or more of the techniques (e.g., methodologies) discussed herein may be performed. In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside (1) on a non-transitory machine-readable medium or (2) in a transmission signal. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 700 may include a hardware processor 702 (e.g., a processing unit, a graphics processing unit (GPU), a hardware processor core, or any combination thereof), a main memory 704, and a static memory 706, some or all of which may communicate with each other via a link 708 (e.g., a bus, link, interconnect, or the like). The machine 700 may further include a display device 710, an input device 712 (e.g., a keyboard), and a user interface (UI) navigation device 714 (e.g., a mouse). In an example, the display device 710, input device 712, and UI navigation device 714 may be a touch screen display. The machine 700 may additionally include a mass storage (e.g., drive unit) 716, a signal generation device 718 (e.g., a speaker), a network interface device 720, and one or more sensors 721, such as a global positioning system (GPS) sensor, compass, accelerometer, or other sensor. The machine 700 may include an output controller 728, such as a serial (e.g., universal serial bus (USB), parallel, or other wired or wireless (e.g., infrared (IR)) connection to communicate or control one or more peripheral devices (e.g., a printer, card reader, etc.).

The mass storage 716 may include a machine-readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the mass storage 716 may constitute machine readable media.

While the machine-readable medium 722 is illustrated as a single medium, the term “machine readable medium” may include a single medium or multiple media (e.g., a centralized or distributed database, and/or associated caches and servers) that configured to store the one or more instructions 724.

The term “machine-readable medium” may include any tangible medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 700, and includes digital or analog communications signals or other intangible medium to facilitate communication of such software.

### Additional Notes & Examples

Example 1 includes subject matter (such as a tangible computer-readable medium having computer executable instructions that, in response to being executed on a computing device, cause the computing device to: receive a request for a hardware resource to accelerate video playback from a requester having at least one priority attribute; determine whether a resource conflict exists for the requested hardware resource based on a status of the requested hardware resource; and in response to determining if the resource conflict exists, assign the hardware resource to accelerate video playback based on the at least one priority attribute and an attribute priority list.

In Example 2, the subject matter of Example 1, may optionally include instructions to maintain a database that includes the priority attribute of each requester; wherein the priority attributes of the requester may change dynamically during video playback.

In Example 3, the subject matter of Examples 1 or 2 may optionally include instructions that cause a computing device to: reallocate the hardware resource in response to a change in the at least one attribute of at least one requester.

In Example 4, the subject matter of Examples 1, 2 or 3 may optionally include instructions that cause a computing device to query a resource manager for a status of the hardware resource; and receive a status response from the resource manager.

In Example 5, the subject matter of Examples 1, 2, 3 or 4, wherein assigning the hardware resource includes creating an instance of a hardware pipeline if the hardware resource is assigned to the requester.

In Example 6, the subject matter of Examples 1, 2, 3, 4 or 5, wherein assigning the hardware resource includes queuing the request if the status response indicates the hardware resource is not assigned to the requester.

In Example 7, the subject matter of Examples 1, 2, 3, 4, 5, or 6, wherein the hardware resource is a video playback engine.

In Example 8, the subject matter of Examples 1, 2, 3, 4, 5, 6, or 7 may optionally include in response to determining if the resource conflict exists, instructing a current resource holder to release the resource.

In Example 9, the subject matter of Examples 1, 2, 3, 4, 5, 6, 7, or 8 may optionally include receiving a notification that the current resource holder has released the resource.

In Example 10, the subject matter of Examples 1, 2, 3, 4, 5, 6, 7, 8, or 9, wherein the requester is a media player.

In Example 11, the subject matter of Examples 1, 2, 3, 4, 5, 6, 7, 8, 9, or 10, wherein the attributes of the media player are selected from a group consisting of: the media player is a foreground window, the media player is a background window, the media player is in a minimized window, the media player is in a maximized window, the media player is visible, the media player is the newest media player, and the media player is hidden.

In Example 12, the subject matter of Examples 1, 2, 3, 4, 5, 6, 7, 8, 9, 10, or 11, wherein the requester is a web browser.

In Example 13, the subject matter of Examples 1, 2, 3, 4, 5, 6, 7, 8, 9, 10, 11, or 12, wherein the attributes of the web browser are selected from a group consisting of: the web browser is a foreground window, the web browser is a background window, the web browser is in a minimized window, the web browser is in a maximized window, the web browser is visible, the web browser is the newest web browser, and the web browser is hidden.

In Example 14, the subject matter of Examples, 2, 3, 4, 5, 6, 7, 8, 9, 10, 11, 12, or 13, wherein the hardware engine is a HTML5-compatible rendering engine.

Example 15 includes subject matter (such as a system, an apparatus, a device, etc.) comprising receiving, in a digital computer system, a request for a hardware resource to accelerate video playback from a requester having at least one priority attribute; determining whether a resource conflict exists for the requested hardware resource based on a status of the requested hardware resource; and in response to determining if the resource conflict exists, assigning the hardware resource to accelerate video playback based on the at least one priority attribute and an attribute priority list.

In Example 16, the subject matter of Example 15, wherein assigning the hardware resource includes creating an instance of a hardware pipeline if the hardware resource is assigned to the requester.

In Example 17, the subject matter of Examples 15 or 16, wherein assigning the hardware resource includes queuing the request if the status response indicates the hardware resource is not assigned to the requester.

In Example 18, the subject matter of Examples 15, 16 or 17 may optionally include querying a resource manager for a status of the hardware resource; and receiving a status response from the resource manager.

In Example 19, the subject matter of Examples 15, 16, 17, or 18, wherein the hardware resource is a video playback engine.

In Example 20, the subject matter of Examples 15, 16, 17, 18, or 19 may optionally include maintaining a database that includes the attribute of each requester; wherein the attributes of the requester may change dynamically during video playback.

In Example 21, the subject matter of Examples 15, 16, 17, 18, 19 or 20 may optionally include reallocating the hardware resource in response to a change in the attribute of at least one requester.

In Example 22, the subject matter of Examples 15, 16, 17, 18, 19, 20 or 21 may optionally include, in response to determining if the resource conflict exists, instructing a current resource holder to release the resource.

In Example 23, the subject matter of Examples 15, 16, 17, 18, 19, 20, 21 or 22 may optionally include receiving a notification that the current resource holder has released the resource.

In Example 24, the subject matter of Examples 15, 16, 17, 18, 19, 20, 21, 22 or 23, wherein the requester is a media player.

In Example 25, the subject matter of Example 24, wherein the attributes of the media player are selected from a group consisting of: the media player is a foreground window, the media player is a background window, the media player is in a minimized window, the media player is in a maximized window, the media player is visible, the media player is the newest media player, and the media player is hidden.

In Example 26, the subject matter of Examples 15, 16, 17, 18, 19, 20, 21, 22 or 23 wherein the requester is a web browser.

In Example 27, the subject matter of Examples 26, wherein the attributes of the web browser are selected from a group consisting of: the web browser is a foreground window, the web browser is a background window, the web browser is in a minimized window, the web browser is in a maximized window, the web browser is visible, the web browser is the newest web browser, and the web browser is hidden.

In Example 28, the subject matter of Examples 15, 16, 17, 18, 19, 20, 21, 22, 23, 24, 25, 26 or 27 wherein the hardware engine is a HTML5-compatible rendering engine.

Example 29 includes subject matter (such as a system, an apparatus, a device, etc.) that includes a hardware engine that supports that playback of at least one video channel; and a page management unit configured to allocate the use of the hardware engine by each of a plurality of media players to execute on the video playback system and configured to utilize the hardware engine to present at least one video on a display screen, the allocation based on a predefined priority that includes an attribute of each of the media players.

In Example 30, the subject matter of Example 29, wherein the hardware engine includes both a decoding pipeline and a rendering module that are linked such that data is transferred directly from the decoding pipeline to the rendering module.

In Example 31, the subject matter of Examples 29 or 30 may optionally include a database that includes the attribute of each of the media players; wherein the attribute of each of the media players may change dynamically during video playback.

In Example 32, the subject matter of Examples 29, 30, or 31, wherein the attribute of the media players is selected from a group consisting of: the media player is a foreground window, the media player is a background window, the media player is in a minimized window, the media player is in a maximized window, the media player is visible, the media player is the newest media player, and the media player is hidden.

In Example 33, the subject matter of Examples 29, 30, 31, or 32, may optionally include a database stored in a computer readable medium including the attribute of each requester; wherein the attributes of the requester may change dynamically during video playback; and the page management unit being further configured to reallocate the hardware resource in response to a change in the attribute of at least one requester.

In Example 34, the subject matter of Examples 29, 30, 31, 32, or 33, wherein the transfer of data from the decoding module to the rendering module does not require a memory copy.

In Example 35, the subject matter of Examples 29, 30, 31, 32, 33, or 34, wherein the at least one video is compatible with HTML5.

In Example 36, the subject matter of Examples 29, 30, 33, 34, or 35, wherein the hardware engine is a HTML5-compatible rendering engine.

In Example 37, the subject matter of Examples 29, 30, 33, 34, 35, or 36, wherein the hardware engine is a video playback engine.

In Example 38, the subject matter of Examples 29, 30, 33, 34, 35, 36 or 37, wherein each of the media players is embedded in a web browser.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

1. At least one machine readable medium comprising a plurality of instructions that in response to being executed on a computing device, cause the computing device to:
receive a request for a hardware resource to accelerate video playback from a requester having at least one priority attribute;
determine whether a resource conflict exists for the requested hardware resource based on a status of the requested hardware resource; and
in response to determining if the resource conflict exists, assign the hardware resource to accelerate video playback based on the at least one priority attribute and an attribute priority list.

2. The at least one machine readable medium as recited in claim 1, further comprising instructions to maintain a database that includes the at least one priority attribute of each requester, wherein the at least one priority attribute of the requester may change dynamically during video playback.

3. The at least one machine readable medium as recited in claim 2, further comprising instructions to reallocate the hardware resource in response to a change in the at least one priority attribute of at least one requester.

4. The at least one machine readable medium as recited in claim 1, comprising instructions to:
query a resource manager for a status of the hardware resource; and
receive a status response from the resource manager.

5. The at least one machine readable medium as recited in claim 1, wherein assigning the hardware resource includes creating an instance of a hardware pipeline if the hardware resource is assigned to the requester.

6. The at least one machine readable medium as recited in claim 1, wherein assigning the hardware resource includes queuing the request if the status response indicates the hardware resource is not assigned to the requester.

7. The at least one machine readable medium as recited in claim 1, further comprising in response to determining if the resource conflict exists, instructing a current resource holder to release the resource.

8. (canceled)

9. The at least one machine readable medium as recited in claim 7, further comprising: receiving a notification that the current resource holder has released the resource.

10. The at least one machine readable medium as recited in claim 1, wherein the requester is a media player and the attributes of the media player are selected from a group consisting of: the media player is a foreground window, the media player is a background window, the media player is in a minimized window, the media player is in a maximized window, the media player is visible, the media player is the newest media player, and the media player is hidden.

11. (canceled)

12. (canceled)

13. The at least one machine readable medium as recited in claim 1, wherein the requester is a web browser, and the attributes of the web browser are selected from a group consisting of: the web browser is a foreground window, the web browser is a background window, the web browser is in a minimized window, the web browser is in a maximized window, the web browser is visible, the web browser is the newest web browser, and the web browser is hidden.

14. (canceled)

15. A method for allocating video playback resources comprising:
receiving, in a digital computer system, a request for a hardware resource to accelerate video playback from a requester having at least one priority attribute;
determining whether a resource conflict exists for the requested hardware resource based on a status of the requested hardware resource; and
in response to determining if the resource conflict exists, assigning the hardware resource to accelerate video playback based on the at least one priority attribute and an attribute priority list.

16. The method of claim 15, wherein assigning the hardware resource includes creating an instance of a hardware pipeline if the hardware resource is assigned to the requester.

17. The method of claim 15, wherein assigning the hardware resource includes queuing the request if the status response indicates the hardware resource is not assigned to the requester.

18. The method of claim 15, further comprising:
querying a resource manager for a status of the hardware resource; and
receiving a status response from the resource manager.

19. The method of claim 15, further comprising: maintaining a database that includes the attribute of each requester; wherein the attributes of the requester may change dynamically during video playback.

20. (canceled)

21. The method of claim 15, further comprising: reallocating the hardware resource in response to a change in the attribute of at least one requester.

22. The method of claim 15, further comprising: in response to determining if the resource conflict exists, instructing a current resource holder to release the resource.

23. The method of claim 22, further comprising: receiving a notification that the current resource holder has released the resource.

24.-28. (canceled)

29. A policy aware video playback system comprising:
a hardware engine that supports that playback of at least one video channel; and
a page management unit configured to allocate the use of the hardware engine by each of a plurality of media players to execute on the video playback system and configured to utilize the hardware engine to present at least one video on a display screen, the allocation based on a predefined priority that includes an attribute of each of the media players.

30. The system of claim 29, wherein the hardware engine includes both a decoding pipeline and a rendering module that are linked such that data is transferred directly from the decoding pipeline to the rendering module.

31. The system of claim 29, further comprising: a database that includes the attribute of each of the media players; wherein the attribute of each of the media players may change dynamically during video playback.

32. The system of claim 29, wherein the attribute of the media players is selected from a group consisting of: the media player is a foreground window, the media player is a background window, the media player is in a minimized window, the media player is in a maximized window, the media player is visible, the media player is the newest media player, and the media player is hidden.

33. The system of claim 29, further comprising:
a database including the attribute of each requester; wherein the attributes of the requester may change dynamically during video playback; and
the page management unit being further configured to reallocate the hardware resource in response to a change in the attribute of at least one requester.

34. The system of claim 29, wherein the hardware engine is a HTML5-compatible rendering engine.

35.-38. (canceled)
